(19) United States
(12) Patent Application Publication
(10) Pub. No.: US 2003/0077442 A1
(43) Pub. Date: Apr. 24, 2003

(54) Release liner and pressure-sensitive adhesive tape or sheet using same

(75) Inventors: Shinji Inokuchi, Ibaraki-shi (JP); Akiko Nozawa, Ibaraki-shi (JP); Naoyuki Nishiyama, Ibaraki-shi (JP)

Correspondence Address: SUGHRUE MION, PLLC, 2100 PENNSYLVANIA AVENUE, N.W., WASHINGTON, DC, 20037, US

(73) Assignee: NITTO DENKO CORPORATION

(21) Appl. No.: 10/270,291

(22) Filed: Oct. 15, 2002

(30) Foreign Application Priority Data
Oct. 23, 2001 (JP) P2001-324903

(51) Int. Cl. B32B 7/12

(52) U.S. Cl. 428/352; 428/409

(57) ABSTRACT

A release liner having an excellent releasability, workability, anti-curling properties and cleanness and little outgassing is described, which comprises the following layers A, B and C, wherein the thickness of the layer A:the sum of the thickness of the layers B and C formed on the either side of the layer A is from 9:1 to 6:4, the total thickness of the release liner is from 40 to 150 μm and the total outgassing developed when the release liner is heated to a temperature of 120° C. for 10 minutes is not greater than 1 μg/cm²:

Layer A: Base material (A);

Layer B: Undercoating layer (B) comprising a low density polyethylene formed on at least one side of the layer A; and

Layer C: A releasing layer (C) formed by a mixed resin composition comprising at least two ethylene-based polymers laminated on the layer B.

### FIELD OF THE INVENTION

The present invention relates to a pressure-sensitive adhesive tape or sheet useful for hard disk driving device and a release liner to be incorporated therein.

### BACKGROUND OF THE INVENTION

A release liner for pressure-sensitive adhesive tape normally comprises a base material for release liner having provided thereon a release agent layer. As such a release agent layer there is known one obtained by applying a silicone-based release treatment to a base material, and then curing the applied treatment. For example, in the art of pressure-sensitive double-sided adhesive tape, the adhesive tape comprises a release liner coated with a silicone-based release agent having provided thereon an adhesive layer comprising an acrylic pressure-sensitive adhesive. However, such a release liner coated with a silicone-based release agent is disadvantageous in that since the silicone compound in the release liner is partly attached to the adhesive layer during the use of the pressure-sensitive adhesive tape, the adhesive layer is contaminated, remarkably impairing the adhesive properties thereof. This kind of a pressure-sensitive adhesive tape is also disadvantageous in that when used to fix electronic apparatus such as HDD (magnetic recording device), particularly in the interior of electronic apparatus, it causes corrosion in the interior of electronic apparatus or erroneous operation thereof. This is because the site of the adhesive layer contaminated by the silicone compound in the release liner becomes a source of siloxane gas.

On the other hand, as release liners which are rendered releasable free of the aforementioned silicone release agent there are known one obtained by extruding a releasing layer made of a low density polyethylene resin onto a base material for release liner while inhibiting surface oxidation of the releasing layer thus extruded so as to laminate the releasing layer on the base material (as disclosed in Japanese Patent Publication No. 1976-20205 and Japanese Utility Model Laid-Open No. 1988-85642), one obtained by extruding a releasing layer made of a mixed resin comprising a low density polyethylene and a low crystallinity ethylene-propylene copolymer or a low crystallinity ethylene-butene-1 random copolymer onto a base material for release liner so as to laminate the releasing layer on the base material (as disclosed in Japanese Patent Publication No. 1982-45790 and Japanese Patent Laid-Open No. 1994-155687), etc. These release liners are provided with a pressure-sensitive adhesive layer at the subsequent step so that it is used as a pressure-sensitive adhesive tape or sheet.

The release liner for pressure-sensitive adhesive tape (or sheet) for hard disk drive (HDD) has the following requirements (1) to (5):

(1) Smooth releasability from the pressure-sensitive adhesive layer;

(2) Adaptability to fine working (With the recent tendency for miniaturization of HDD, the size of sticking of tape has decreased);

(3) Anti-curling properties of release liner;

(4) Low outgassing (Gases derived from hydrocarbon are considered to cause erroneous operation of HDD besides silicone-based compounds conventionally known as contaminant sources); and

(5) Cleanness (For example, paper dust derived from paper base material, etc. becomes a contaminant source)

As the aforementioned release liner which are rendered releasable free of silicone release agent, the release liner obtained by extruding the resin while inhibiting surface oxidation of the releasing layer so as to laminate the resin (as disclosed in Japanese Patent Publication No. 1976-20205) does not exhibit a good releasability with respect to a pressure-sensitive adhesive having a high adhesivity. When the release liner is peeled off a pressure-sensitive adhesive layer, the pressure-sensitive adhesive is caught by the releasing layer or peeling occurs in a pulsed form (so-called stick slip), roughening the pressure-sensitive adhesive layer. Thus, the desirable properties cannot be attained. On the other hand, the release liner obtained by extruding a releasing layer made of a mixed resin so as to laminate the releasing layer (as disclosed in Japanese Patent Publication No. 1982-45790) can be smoothly released from the pressure-sensitive adhesive layer but is disadvantageous in that it leaves something to be desired in cleanness because paper or the like is used as a base material for release liner, it exhibits a deteriorated cuttability because the releasing layer elongates during the formation into the sticking shape for member and it exhibits much outgassing.

### SUMMARY OF THE INVENTION

It is therefore an aim of the invention to provide a release liner which allows the releasing layer and the pressure-sensitive adhesive layer to be smoothly released from each other without having any silicone-based release agent incorporated in the releasing layer, exhibits a good adaptability to fine working, excellent anti-curling properties and little outgassing and attains an excellent cleanness, and a pressure-sensitive adhesive tape or sheet comprising such a release liner.

The inventors made extensive studies to accomplish the aforementioned aim. As a result, it was found that a pressure-sensitive adhesive tape or sheet comprising a release liner having a laminated structure comprising various layers formed by a specific plastic material and showing a predetermined range of total outgassing developed upon heating exhibits high level properties required for pressure-sensitive adhesive tape or sheet for HDD. The present invention has been achieved based on the finding.

The invention provides a release liner comprising the following layers A, B and C, wherein the ratio of the thickness of the layer A to the sum of the thickness of the layers B and C formed on the either side of the layer A ((thickness of layer A):(sum of thickness of layers B and C)) is from 9:1 to 6:4, the total thickness of the release liner is from 40 μm to 150 μm and the total outgassing developed when the release liner is heated to a temperature of 120° C. for 10 minutes is not greater than 1 μg/cm²:

Layer A: Base material (A);

Layer B: Undercoating layer (B) comprising a low density polyethylene formed on at least one side of the layer A; and

Layer C: A releasing layer (C) formed by a mixed resin composition comprising at least two ethylene-based polymers selected from the group consisting of straight-chain low density polyethylene, low density polyethylene and copolymer of ethylene with C₃-C₁₀ α-olefin laminated on the layer B.

The base material (A) is preferably a film or sheet formed by a polypropylene or polyester. The release liner may comprise the undercoating layer (B) and the releasing layer (C) laminated on at least one side of the base material (A) in a tandem process.

The invention includes a pressure-sensitive adhesive tape or sheet comprising a pressure-sensitive adhesive layer (D) having laminated thereon the release liner in such an arrangement that the pressure-sensitive adhesive layer (D) and the releasing layer (C) come in contact with each other.

The pressure-sensitive adhesive tape or sheet of the invention can be used as a pressure-sensitive adhesive tape or sheet for hard disk drive to advantage.

### BRIEF DESCRIPTION OF THE DRAWINGS

FIG. 1 is a schematic sectional view illustrating an embodiment of the release liner of the invention;

FIG. 2 is a schematic sectional view illustrating an embodiment of the pressure-sensitive adhesive tape (or sheet) of the invention;

FIG. 3 is a schematic diagram illustrating an embodiment of the process for producing the release liner of the invention in a tandem process;

FIG. 4 is a schematic sectional view illustrating another embodiment of the pressure-sensitive adhesive tape (or sheet) of the invention;

FIG. 5 is a schematic sectional view illustrating a further embodiment of the pressure-sensitive adhesive tape (or sheet) of the invention; and

FIG. 6 is a schematic sectional view illustrating a still further embodiment of the pressure-sensitive adhesive tape (or sheet) of the invention.

### DESCRIPTION OF THE REFERENCE NUMERALS AND SIGNS

1 Base material (A) as layer A

2 Undercoating layer (B) as layer B

3 Releasing layer (C) as layer C

4 Release liner

5 Pressure-sensitive adhesive layer (D)

6 Supporting base material (E)

7 Pressure-sensitive adhesive tape

71 Pressure-sensitive adhesive tape

72 Pressure-sensitive adhesive tape

73 Pressure-sensitive adhesive tape

8 Feed portion

9 Die for undercoating layer (B) (first die)

10 Die for releasing layer (C) (second die)

11 Winding portion

12 Drying oven

13 Coater for primer coating layer

### DETAILED DESCRIPTION OF THE INVENTION

The invention will be further described hereinafter occasionally in connection with the attached drawings. Where the members and portions are the same, the same numbers are used.

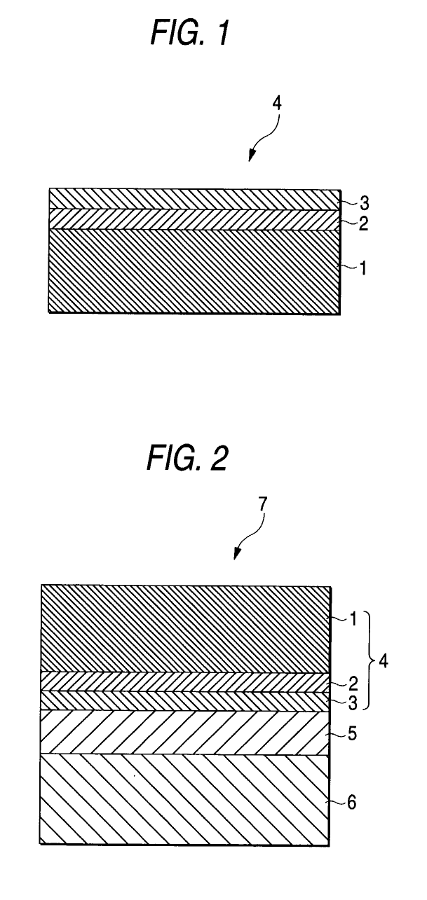

FIG. 1 is a schematic sectional view illustrating an embodiment of the release liner according to the invention. FIG. 2 is a schematic sectional view illustrating an embodiment of the pressure-sensitive adhesive tape (or sheet) of the invention comprising this release liner. In FIGS. 1 and 2, the reference numeral 1 indicates a base material (A) as layer A, the reference numeral 2 indicates a undercoating layer (B) as layer B, the reference numeral 3 indicates a releasing layer (C) as layer C, the reference numeral 4 indicates a release liner, the reference numeral 5 indicates a pressure-sensitive adhesive layer (D), the reference numeral 6 indicates a supporting base material (E), and the reference numeral 7 indicates a pressure-sensitive adhesive tape.

The release liner 4 of FIG. 1 comprises the base material (A) 1, the undercoating layer (B) 2 formed on one side of the base material (A) 1, and the releasing layer (C) 3 provided on the undercoating layer (B) 2. The pressure-sensitive adhesive tape 7 of FIG. 2 comprises the pressure-sensitive adhesive layer (D) 5 provided on the supporting base material (E) 6. The release liner 4 is laminated on the pressure-sensitive adhesive layer (D) 5 in such an arrangement that the releasing layer (C) 3 comes in contact with the pressure-sensitive adhesive layer (D) 5.

The base material (A) 1 as layer A can act as a reinforcement layer for the entire release liner 4. The base material (A) 1 may be formed by any material which generates no undesirable contaminants (e.g., dust) in the process for the production of release liner and has adaptability to fine working.

More specifically, as the base material (A) 1 there may be used a film or sheet formed by a thermoplastic resin (e.g., polyethylene-based resin such as high density polyethylene, low density polyethylene and linear low density polyethylene, polyolefin-based resin such as polypropylene and poly-4-methylpentene-1, nylon, polyester such as polyethylene terepthalate, styrene-based resin such as polystyrene, polyvinyl chloride, other known thermoplastic resins), metal foil (e.g., aluminum foil, stainless steel foil, copper foil) or the like. The thermoplastic resins or metals as the material of the base material (A) 1 may be used singly or in combination of two or more thereof. Preferred among these base material (A) 1 materials constituting the film or sheet is polypropylene or polyester.

The base material (A) 1 may have either a single-layer structure or a multi-layer structure. The thickness of the base material (A) 1 is not specifically limited but may fall within the range of from 10 μm to 100 μm, preferably from 25 μm to 80 μm, more preferably from 30 μm to 60 μm. When the thickness of the base material (A) 1 falls outside the above defined range, the resulting product is disadvantageous in that it exhibits a deteriorated releasability during peeling or deteriorated adaptability to fine working or is subject to curling during the production of release liner.

In the invention, the base material (A) 1 may be subjected to surface treatment such as corona discharge treatment.

The undercoating layer (B) 2 as layer B is formed on one side of the base material (A) 1 as layer A in FIG. 1. The undercoating layer (B) 2 may be formed by a low density polyethylene. For example, in the case where the undercoating layer (B) 2 is laminated in a tandem process as described later, a low density polyethylene having the grade marketed for lamination can be preferably used among low density polyethylenes. In some detail, low density polyethylenes having a melt flow rate (MFR) of from 4 to 15 g/10 min (according to JIS K 6760) can be preferably used.

The undercoating layer (B) may have either a single-layer structure or a multi-layer structure. The thickness of the undercoating layer (B) 2 may be, e.g., from 5 μm to 20 μm, preferably from 8 μm to 15 μm. When the thickness of the undercoating layer (B) 2 is too small, the undercoating layer (B) 2 is not uniform. On the other hand, when the thickness of the undercoating layer (B) 2 is too great, the undercoating layer (B) 2 exhibits a deteriorated resistance to curling if provided on only one side of the base material (A). Even if provided on the both sides of the base material (A), the undercoating layer (B) 2 may be lack of workability.

The releasing layer (C) 3 as layer C is laminated on the undercoating layer (B) as layer B. The releasing layer (C) 3 may be formed by a mixed resin composition made of at least two ethylene-based polymers selected from the group consisting of straight-chain low density polyethylene, low density polyethylene and copolymer of ethylene with C₃-C₁₀ α-olefin (hereinafter occasionally referred to as “ethylene-α-olefin copolymer”). As the C₃-C₁₀ α-olefin in the ethylene-α-olefin copolymer (copolymer of ethylene with C₃-C₁₀ α-olefin) there may be used at least one α-olefin (comonomer) selected from the group consisting of propylene, butene-1, hexene-1, 4-methylpentene-1 and octene-1.

The ethylene-based polymer to be incorporated in the releasing layer (C) preferably contains at least a straight-chain low density polyethylene, particularly a straight-chain low density polyethylene as a main component together with a low density polyethylene and an ethylene-a-olefin copolymer. In the case where a straight-chain low density polyethylene is contained as a main component and a low density polyethylene and an ethylene-α-olefin copolymer are contained together, the proportion of these components is not specifically limited, but the proportion of low density polyethylene and ethylene-a-olefin copolymer are preferably from 1 to 25 parts by weight and from 1 to 20 parts by weight, respectively, based on 100 parts by weight of straight-chain low density polyethylene. When the proportion of these components falls outside the above defined range, the desirable releasabilities can be impaired or defectives such as insufficient formability can occur.

The comonomer component to be used in the straight-chain low density polyethylene together with ethylene may be properly selected. Particularly preferred examples of the comonomer include 1-hexene and 1-octene.

The ethylene-based polymer can be easily obtained by properly selecting polymerization reaction conditions, subsequent purification and fractionation conditions according to a known method. Commercial products may be used as they are.

As the ethylene-based polymer related to the releasing layer (C) there is preferably used an ethylene-based polymer having a melt flow rate (MFR) of from 4 to 15 g/10 min (according to JIS K 6760) from the same standpoint as in the undercoating layer (B) 2.

The releasing layer (C) may have either a single-layer structure or a multi-layer structure. The thickness of the releasing layer (C) 3 may be, e.g., from about 5 μm to 20 μm, preferably from about 7 μm to 15 μm. When the thickness of the releasing layer (C) 3 is too small, the releasing layer (C) 3 has ununiform thickness. On the contrary, when the thickness of the releasing layer (C) 3 is too great, the releasing layer (C) 3 is subject to curling if provided on only one side of the base material (A). Further, if provided on the both sides of the base material (A), outgassing can increase.

The release liner 4 according to FIG. 1 comprises the base material (A) 1, the undercoating layer (B) 2 formed on one side of the base material (A) 1, and the releasing layer (C) formed on the undercoating layer (B) 2. In the invention, the undercoating layer (B) 2 and the releasing layer (C) 3 may be provided on the both sides of the base material (A) 1. In some detail, the release liner of the invention comprises the base material (A) 1, the undercoating layer (B) 2 formed on at least one side of the base material (A) 1, and the releasing layer (C) 3 formed on the undercoating layer (B) 2.

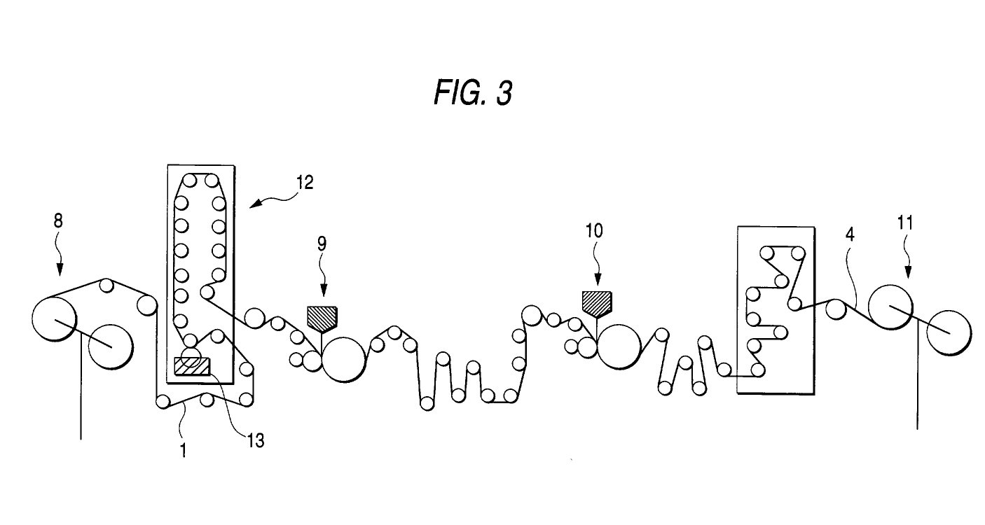

In the invention, the base material (A), the undercoating layer (B) and the releasing layer (C) can be laminated in this order to prepare a release liner. This lamination method can be properly selected from known lamination methods. A tandem process lamination method (particularly tandem extrusion lamination method) can be employed to advantage. In some detail, the undercoating layer (B) and the releasing layer (C) are preferably laminated on the surface of the substrate (A) according to the tandem process shown in FIG. 3. FIG. 3 is a schematic diagram illustrating an embodiment of the production of the release liner of the invention according to a tandem process. In FIG. 3, the reference numeral 8 indicates a feed portion, the reference numeral 9 indicates a die for undercoating layer (B) (first die), the reference numeral 10 indicates a die for releasing layer (C) (second die), the reference numeral 11 indicates a winding portion, the reference numeral 12 indicates a drying oven, and the reference numeral 13 indicates a primer coating layer coater. The reference numerals 1 and 4 indicate a base material (A) and a release liner, respectively, as in FIGS. 1 and 2.

In accordance with the production method shown in FIG. 3, the feed portion 8 feeds a sheet as base material (A) 1. If necessary, a primer coating compound is applied to the sheet using a primer coating layer coater 13 to form a primer coating layer. A low density polyethylene which is a constituent of the undercoating layer (B) is extruded from the first die 9 onto the surface of the base material (A) 1 (onto the surface of the primer coating layer formed on the base material (A) 1, if the primer coating layer has been formed). Subsequently, a mixed resin composition comprising an ethylene-based polymer which is a constituent of the releasing layer (C) is extruded from the second die 10 onto the surface of the undercoating layer (B). Thus, a release liner 4 can be prepared.

Such a tandem process lamination method (e.g., tandem extrusion lamination method) involves continuous extrusion at one step that allows continuous lamination of undercoating layer (B) and releasing layer (C) and thus is desirable from the standpoint of production cost and very effective. Other examples of lamination method include dry lamination method, coextrusion lamination method, and extrusion lamination method (single-layer extrusion process). These lamination methods have various disadvantages and problems as described later and thus are not desirable.

Referring to other lamination methods, the dry lamination method involves production of film. However, the forming temperature at which the film is prepared is normally low, causing an increase in outgassing (generated amount of outgas) in the resulting release liner. Further, blocking can occur while the product is in storage or transportation in the form of film. In order to prevent blocking, it is necessary that an antiblocking agent or slipping agent be separately incorporated in the material. These agents can be a source of outgass. Thus, the dry lamination method is not desirable. The dry lamination method is further disadvantageous in that the thickness of the film cannot be reduced or the release film is stretched during lamination, impairing the releasabilities.

The coextrusion lamination method is disadvantageous in that when the forming temperature of releasing layer is raised, the resulting surface oxidation causes the releasabilities to be impaired. On the contrary, when the forming temperature is low, the resulting adhesion of the releasing layer to the base material (A) is deteriorated.

The extrusion lamination method (single-layer extrusion process) comprises laminating a undercoating layer (B) on a base material (A) optionally with the interposition of a primer coating layer, winding the laminated material, and then laminating a releasing layer (C) on the undercoating layer (B) at a separate step. This method is disadvantageous in that since the extrusion temperature of the resin composition (mixed resin composition containing an ethylene-based polymer) which constitutes the releasing layer (C) is low, the adhesion between the undercoating layer (B) and the releasing layer (C) cannot be sufficiently secured, remarkably impairing the function of release liner.

More specifically, in the case where a low density polyethylene which is a constituent of the undercoating layer (B) is extruded from an extruder onto the base material (A) so that it is laminated thereon, the extrusion temperature is preferably, e.g., from 310° C. to 330° C. When the extrusion temperature is too low (e.g., lower than 310° C.), the resulting adhesion is insufficient. On the contrary, when the extrusion temperature is too high (e.g., higher than 330° C.), the resulting decomposition of the resin can cause fuming or odor development.

In the case where a mixed resin composition comprising an ethylene-based polymer which is a constituent of the releasing layer (C) is extruded from an extruder onto the undercoating layer (B) so that it is laminated thereon, the extrusion temperature is preferably, e.g., from 265° C. to 280° C. When the extrusion temperature is too low (e.g., lower than 265° C.), the resulting formability is insufficient, causing the drop of thickness accuracy. Further, even if a desirable formability can be secured, the desired low outgassing properties cannot be secured. On the contrary, when the extrusion temperature is too high (e.g., higher than 280° C.), the resulting oxidation of the resin can cause the releasabilities to be remarkably impaired.

In the case where the undercoating layer (B) and the releasing layer (C) are extruded from extruders so that they are laminated on the base material, it is preferred that extrusion be conducted in a tandem process so that lamination is effected at one step.

The various layers constituting the release liner of the invention may comprise a small amount of other components (e.g., resin component, additives) incorporated therein as necessary.

In the invention, a primer coating layer and/or a metal deposit layer may be formed interposed between the base material (A) and the undercoating layer (B) as necessary. As the anchor coating agent to be used as the primer coating layer there is preferably used any material which can provide a sufficient adhesion between the base material (A) and the undercoating layer (B), more preferably any material which gives no defects when used in the release liner for pressure-sensitive adhesive tape (or sheet) for HDD. In some detail, as the anchor coating agent there is preferably used an anchor coating agent obtained by dissolving an ester urethane-based adhesive or ether urethane-based adhesive in a solvent (e.g., organic solvent such as ester acetate (e.g., ethyl acetate) and ketone (e.g., methyl ethyl ketone, acetone). An anchor coating agent containing an ethyleneimine-based compound or silane coupling agent is preferably not used because it cause corrosion or contamination in the interior of HDD. The thickness of the primer coating layer is preferably from 0.5 μm to 1.5 μm. When the thickness of the primer coating layer is less than 0.5 μm, the resulting adhesion of the primer coating layer to the undercoating layer (B) 2 is insufficient. On the contrary, when the thickness of the primer coating layer is greater than 1.5 μm, it can cause outgassing.

Examples of the metal which constitutes the metal deposit layer include aluminum (Al), silver (Ag), gold (Au), and nickel (Ni). The deposition of metal may be conducted by any conventional method such as vacuum deposition method. The thickness of the metal deposit layer is normally from 0.01 μm to 2 μm, preferably from 0.04 μm to 1 μm. When the thickness of the metal deposit layer is less than 0.01 μm, a uniform deposit layer can be difficultly obtained. On the contrary, when the thickness of the metal deposit layer is greater than 2 μm, the resulting metal deposit layer can be easily separated from the opposing layers.

Referring to the ratio of the thickness of the various layers in the laminated structure of the release liner of the invention, the ratio of the thickness of the base material (A) to the sum of the thickness of the undercoating layer (B) and the releasing layer (C) formed on any one side of the base material (A) ((thickness of base material (A):(thickness of undercoating layer (B)+thickness of releasing layer (C))) may fall within the range of from 9:1 to 6:4, preferably from 8:2 to 7:3. When the sum of the thickness of the undercoating layer (B) and the releasing layer (C) is too great as compared with that of the base material (A), the release liner thus obtained by lamination can be curled due to the effect of shrinkage of the polyethylene-based material. When used for pressure-sensitive adhesive tape (or sheet) for HDD, this release liner impedes working during fine punching or the like. Further, since the polyethylene-based material extends too much during punching, the release liner exhibits a deteriorated cuttability, giving a torn work to disadvantage.

In order to secure such an accuracy that the thickness of the layer obtained by the extrusion lamination method is uniform, it is preferred that the thickness of the undercoating layer (B) and the releasing layer (C) each be not smaller than 7 μm. However, when this point is taken into account, the ratio of the thickness of the base material (A) can be raised. When the thickness of the base material (A) is too great, the resulting release liner exhibits a raised rigidity, causing undesirable lifting during working.

The total thickness of the release liner is preferably from 40 μm to 150 μm, more preferably from 50 μm to 120 μm. When the release liner has the undercoating layer (B) and the releasing layer (C) provided on only one side of the base material (A), the total thickness of the release liner is preferably from 40 μm to 100 μm, more preferably from 50 μm to 100 μm. When the total thickness of the release liner falls within this range, the release liner, if used for pressure-sensitive adhesive tape (or sheet) for HDD, can be provided with sufficient releasability and cuttability. When the total thickness of the release liner is too small (e.g., less than 40 μm), release can be difficultly initiated, deteriorating workability. On the contrary, when the total thickness of the release liner is too great (e.g., greater than 100 μm, if the undercoating layer (B) and the releasing layer (C) are provided on only one side of the base material (A)), the resulting release liner exhibits a raised rigidity, causing undesirable lifting during working.

It is essential that the release liner have a total outgassing (total generated amount of outgas) of not greater than 1 μg/cm², preferably not greater than 0.8 μg/cm² when heated for 10 minutes at 120° C. When the total outgassing developed upon heating to 120° C. for 10 minutes is not greater than 1 μg/cm², outgassing due to the transfer from the release liner can be lessened or eliminated if the resulting release liner is used for pressure-sensitive adhesive tape (or sheet) for HDD. Thus, even if the pressure-sensitive adhesive tape (or sheet) for HDD is used in the interior of HDD, it is not likely that corrosion or erroneous operation can occur. On the contrary, when the total outgassing developed upon heating to 120° C. for 10 minutes is greater than 1 μg/cm², outgassing components are transferred from the release liner, if used for pressure-sensitive adhesive tape (or sheet) for HDD, to the pressure-sensitive adhesive layer (D) of the pressure-sensitive adhesive tape (or sheet) for HDD upon mounting of the pressure-sensitive adhesive tape (or sheet) for HDD on HDD, making it much likely that the long-term reliability of HDD can be remarkably impaired.

It has been already made apparent from the inventors' study that the outgassing components include hydrocarbons having from about 8 to 20 carbon atoms, and solvent components.

As shown in FIG. 2, the pressure-sensitive adhesive tape (or sheet) of the invention has a structure comprising the aforementioned release liner 4 laminated on the pressure-sensitive adhesive layer (D) 5 in such an arrangement that the releasing layer (C) 3 of the release liner 4 and the pressure-sensitive adhesive layer (D) 5 come in contact with each other. In FIG. 2, the pressure-sensitive adhesive tape (or sheet) 7 is shown having the supporting base material (E) 6 and the pressure-sensitive adhesive layer (D) 6 laminated thereon.

As the supporting base material (E) 6 there may be used a plastic film or sheet formed by a polyolefin-based resin such as high density polyethylene, low density polyethylene, linear low density polyethylene, polypropylene and poly-4-methylpentene-1, polyester such as polyethylene terephthalate, styrene-based resin such as polystyrene and thermoplastic resin such as polyvinyl chloride, a foam thereof, a foil of metal such as aluminum, stainless steel and copper, or lamination thereof. Examples of such a lamination include a lamination of a film of polyester such as polyethylene terepthalate with a foil of metal such as aluminum and copper (polyester film/metal foil, polyester film/metal foil/polyester film). The thickness of the supporting base material (E) 6 may be properly predetermined so far as handleability cannot be impaired but is normally from 5 μm to 300 μm, preferably from 10 μm to 200 μm.

As the pressure-sensitive adhesive constituting the pressure-sensitive adhesive layer (D) there may be used any of various pressure-sensitive adhesives. A preferred example of these pressure-sensitive adhesives is a poly(meth)acrylic acid ester-based adhesive (acrylic adhesive). This adhesive is prepared by optionally adding various additives such as crosslinking agent, tackifier, softener, antioxidant and filler to an acrylic polymer obtained by a polymerization method such as solution polymerization and emulsion polymerization as a primary agent. The aforementioned acrylic polymer can be produced by the copolymerization of a monomer mixture obtained by optionally adding other monomers such as 2-hydroxyethyl (meth)acrylate, (meth)acrylic acid, styrene and vinyl acetate as a copolymerizable modifying monomer to an alkyl (meth)acrylate such as butyl (meth)acrylate and 2-ethylhexyl (meth)acrylate as a main component. The use of such an acrylic adhesive comprising an acrylic polymer as a primary agent makes it possible to give extremely excellent results in releasability.

Other preferred examples of the pressure-sensitive adhesive employable herein include a polyester-based adhesive comprising as a primary agent a polyester-based polymer comprising an aliphatic carbonate diol as an essential polyol component. The aforementioned aliphatic carbonate diol can be obtained, e.g., by the reaction of a diol component such as butanediol with a carbonate compound such as ethylene carbonate.

The form of the pressure-sensitive adhesive is not specifically limited but is normally solvent-based, emulsion-based or hot melt-based (solvent-free) from the standpoint of handleability. The aforementioned various pressure-sensitive adhesives such as acrylic and polyester-based pressure-sensitive adhesives may be used singly or in admixture of two or more thereof obtained by known method so far as the properties of adhesive cannot be impaired. For example, an adhesive containing both the acrylic polymer and polyester-based polymer may be used.

The pressure-sensitive adhesive layer (D) can be formed by applying a solvent-based, emulsion-based or hot melt adhesive to, for example, the releasing layer (C), and then drying the coated material. The thickness of the pressure-sensitive adhesive layer (D) thus formed is from about 10 μm to 200 μm, preferably from about 20 μm to 150 μm.

The pressure-sensitive adhesive layer (D) may contain an interlayer or the like. An example of the interlayer is a thin sheet-like material (e.g., plastic film or sheet, foam thereof, metal foil). The thickness of the interlayer may fall within the range of from about 10 μm to 100 μm.

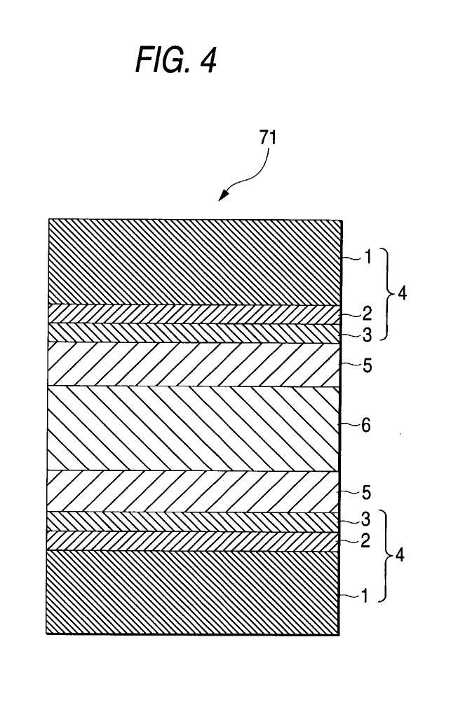

The pressure-sensitive adhesive tape (or sheet) of the invention is not limited to the aforementioned form but may be in any form. FIG. 4 is a schematic diagram illustrating another embodiment of the pressure-sensitive adhesive tape (or sheet) of the invention. In this embodiment of pressure-sensitive adhesive tape 71, the pressure-sensitive adhesive layer (D) 5 is provided on the both sides of the supporting base material (E) 6. The aforementioned release liner 4 is laminated on the two pressure-sensitive adhesive layers (D) 5 in such an arrangement that the release liner (C) 3 comes in contact with the pressure-sensitive adhesive layers (D) 5. This pressure-sensitive adhesive tape 71 is used as a double-sided adhesive tape (double-sided adhesive tape with a base material).

The double-sided adhesive tape with a base material 71 shown in FIG. 4 comprises as a release liner one having a undercoating layer (B) 2 and a releasing layer (C) 3 formed on one side of a base material (A) 1. In this arrangement, a release liner 4 is laminated on two pressure-sensitive adhesive layers (D) 5. As the double-sided adhesive tape with a base material there may be used a release liner having a undercoating layer (B) and a releasing layer (C) formed on both sides of a base material (A). In this case, the release liner 4 may be laminated on any one of the pressure-sensitive adhesive layers (D) 5 formed on the both sides of the supporting base material (E) 6.

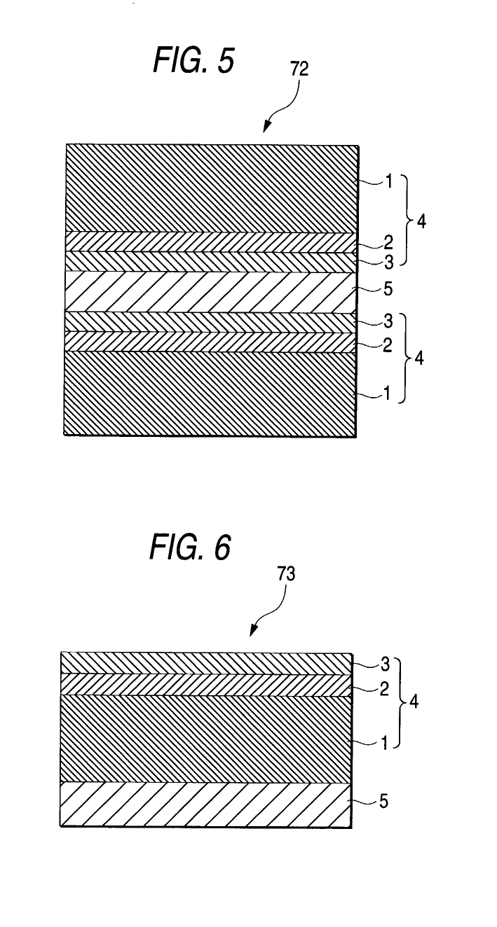

FIG. 5 is a schematic sectional view illustrating a further embodiment of the pressure-sensitive adhesive tape (or sheet) of the invention. This embodiment of pressure-sensitive adhesive tape 72 comprises the pressure-sensitive adhesive layer (D) 5 laminated on the releasing layer (C) 3 of the release liner 4 and is free of supporting base material (E). This pressure-sensitive adhesive tape 72 is used as a double-sided adhesive tape free of base material (baseless double-sided adhesive tape).

FIG. 6 is a schematic sectional view illustrating a still further embodiment of the pressure-sensitive adhesive tape (or sheet) of the invention. This embodiment of pressure-sensitive adhesive tape 73 comprises the pressure-sensitive adhesive layer (D) 5 provided on the base material (A) 1 of the release liner 4. By winding this pressure-sensitive adhesive tape 73, the pressure-sensitive adhesive layer (D) 5 and the releasing layer (C) 3 are laminated on each other.

Thus, the pressure-sensitive adhesive tape (or sheet) of the invention is preferably arranged such that the release liner 4 is laminated on the pressure-sensitive adhesive layer (D) 5 with the releasing layer (C) 3 of the release liner 4 and the pressure-sensitive adhesive layer (D) 5 coming in contact with each other. In other words, the supporting base material (E) 6 may or may not be provided. The pressure-sensitive adhesive tape (or sheet) of the invention may be a one-sided adhesive tape (e.g., adhesive tape which is or is not releasable on the back side thereof) or a double-sided adhesive tape (e.g., double-sided adhesive tape with a base material, baseless double-sided adhesive tape).

The pressure-sensitive adhesive tape (or sheet) of the invention is useful as a silicone-free adhesive tape or sheet for the art of electronic material, particularly hard disk device for computer.

The release liner of the invention exhibits a low outgassing. When used for pressure-sensitive adhesive tape for HDD, the release liner of the invention has no adverse effects on HDD and thus exhibits remarkably excellent effects. The release liner of the invention also exhibits an excellent releasability and workability. The release liner of the invention further exhibits excellent anti-curling properties.

On the other hand, since the pressure-sensitive adhesive tape of the invention comprises the aforementioned release liner, troubles due to silicone compound can be eliminated. Further, the pressure-sensitive adhesive tape exhibits an excellent releasability and workability. Moreover, the pressure-sensitive adhesive tapes of the invention may be free of base material which gives contaminants such as paper base material (e.g., base material of release liner, supporting base material of pressure-sensitive adhesive tape) and thus they can attain a good cleanness.

The invention will be further described in the following examples, but the invention should not be construed as being limited thereto. The term “parts” as used hereinafter is meant to indicate “parts by weight”.

### EXAMPLE 1

100 parts of an ester urethane-based anchor coating agent (trade name “AD-527”, produced by TOYO MORTON LTD.) were mixed with 7 parts of a hardening accelerator (trade name “CAT HY-91”, produced by TOYO MORTON LTD.). To the mixture was then added ethyl acetate in such an amount that the solid concentration reached 5% by weight to prepare an anchor coating agent solution.

The anchor coating agent solution was applied to the surface of a polyethylene terephthalate film (trade name “Lumirror S-105-50”, produced by TORAY INDUSTRIES, INC.; thickness: 50 μm; base material (A)) to a thickness of about 1 μm (dry thickness: 0.1 μm) by means of a roll coater, and then dried at a temperature of 80° C. A low density polyethylene (trade name “Suntec L-1850A”, produced by ASAHI KASEI CORPORATION) was then extruded onto the anchor coat layer at a temperature of 325° C. under die to a dry thickness of 10 μm according to a tandem process so that it was laminated thereon to form a undercoating layer (B). Subsequently, a resin composition (constituent of the releasing layer (C)) obtained by mixing 100 parts of a mixed resin (trade name “Moretec 0628D”, produced by IDEMITSU PETROCHEMICAL CO., LTD.; mixed resin having 15% by weight of a low density polyethylene incorporated in a straight-chain low density polyethylene) with 10 parts of an ethylene-propylene copolymer (trade name “Toughmer P0180”, produced by Mitsui Chemical Inc.) was extruded onto the undercoating layer (B) at a temperature of 273° C. under die to a dry thickness of 10 μm so that it was laminated thereon to form a releasing layer (C). Thus, a release liner was prepared. In the release liner thus prepared, the ratio of the thickness of the polyethylene terephthalate film as base material (A) to the thickness of the laminated resin layer (undercoating layer (B) and releasing layer (C)) was 5:2 (the thickness of the polyethylene terephthalate film:the thickness of the laminated resin layer). The total thickness of the release liner was 70.17 μm.

Separately, 93 parts of n-butyl acrylate and 7 parts of acrylic acid were subjected to ordinary solution polymerization with ethyl acetate as a solvent in the presence of azobisisobutyronitrile as an initiator to obtain a solution of an acrylic polymer having a weight-average molecular weight of 1,500,000 (solid concentration: 25% by weight). This solution was mixed with a crosslinking agent (trade name “Colonate L”, produced by Nippon Polyurethane Industry Co., Ltd.; tolylenediisocyanate adduct of trimethylolpropane) in a proportion of 2 parts based on 100 parts of acrylic polymer to obtain an adhesive composition solution (acrylic pressure-sensitive adhesive).

This adhesive composition solution was applied to a laminated base material (trade name “Arumifukugohin AL/PET 7-50”, produced by SUMIKEI ALUMINUM Co., Ltd.; supporting base material (E)) made of a polyethylene terephthalate (thickness: 50 μm) and an aluminum foil (thickness: 7 μm), and then dried at a temperature of 140° C. for 3 minutes to form an adhesive composition layer (pressure-sensitive adhesive layer (D)) having a thickness of 25 μm. The release liner was then laminated on the adhesive side of the laminate in such an arrangement that the releasing layer (C) came in contact with the adhesive side (surface of the pressure-sensitive adhesive layer (D)) to prepare a pressure-sensitive adhesive tape.

### EXAMPLE 2

A release liner and a pressure-sensitive adhesive tape were prepared in the same manner as in Example 1 except that as the base material (A) there was used an aluminum-deposited polyethylene terephthalate film (trade name “Metalumy TS#50”, produced by TOYO METALLIZING CO.,LTD; thickness: 50 μm) and as the constituent of the releasing layer (C) there was used “Moretec 0628D”, produced by IDEMITSU PETROCHEMICAL CO., LTD.; mixed resin having 15% by weight of a low density polyethylene incorporated in a straight-chain low density polyethylene).

### COMPARATIVE EXAMPLE 1

A release liner and a pressure-sensitive adhesive tape were prepared in the same manner as in Example 2 except that as the base material (A) there was used a polyethylene terephthalate film (trade name “Diafoil T-100G50”, produced by Mitsubishi Chemical Polyester Film Co., Ltd.; thickness: 50 μm) and the thickness of the undercoating layer (B) and the releasing layer (C) were each 22.5 μm.

### COMPARATIVE EXAMPLE 2

A mixed resin comprising 100 parts of a straight-chain low density polyethylene (trade name “J-REX LL AC41SA”, produced by Japan Polyolefins Co., Ltd.), 2.5 parts of a anti-blocking agent (trade name “BB-32”, produced by IDEMITSU PETROCHEMICAL CO., LTD.) and 15 parts of an ethylene-propylene copolymer (trade name “Toughmer P0180”, Mitsui Chemical Inc.) was subjected to inflation molding at an extrusion temperature of 220° C., a blow ratio of 1.38, a die aperture of 500 mm, a die gap of 2 mm, a spread width of 1,065 mm and a take-off speed of 25 m/min to prepare a release film having a thickness of 25 μm.

100 parts of an ester urethane-based anchor coating agent (trade name “AD-527”, produced by TOYO MORTON LTD.) were mixed with 7 parts of a hardening accelerator (trade name “CAT HY-91”, produced by TOYO MORTON LTD.). Thereafter, to the mixture was added ethyl acetate in such an amount that the solid concentration reached 30% by weight to prepare an anchor coating agent solution. This anchor coating agent solution was applied to a polyethylene terephthalate film (trade name “Lumirror S-27-50”, produced by TORAY INDUSTRIES, INC.; thickness: 50 μm; base material) by means of a bar coater to a dry thickness of 3 μm, and then dried at a temperature of 80° C. to form a primer coating layer.

On the primer coating layer was then laminated the aforementioned release film by a dry lamination method to prepare a release liner. In the release liner, the ratio of the thickness of the polyethylene terephthalate film as base material to the thickness of the laminated resin layer (release film) (the thickness of the polyethylene terephthalate film:the thickness of the laminated resin layer) was 2:1. The total thickness of the release liner was 78 μm.

A pressure-sensitive adhesive tape was prepared in the same manner as in Example 1 except that this release liner was used.

### COMPARATIVE EXAMPLE 3

On a polyethylene terephthalate film (trade name “Lumirror S-27-38”, produced by TORAY INDUSTRIES, INC.; thickness: 38 μm; base material) was laminated a release film (trade name “TUX VCS#60”, three-layer linear low density polyethylene T-die cast film having a thickness of 60 μm, produced by Tohcello Co., Ltd.) with the interposition of an adhesive layer made of an acrylic polymer (thickness: 10 μm) by a dry lamination method to prepare a release liner. In the release liner, the ratio of the thickness of the polyethylene terephthalate film as base material to the thickness of the laminated resin layer (release film) was 38:60 (the thickness of the polyethylene terephthalate film:the thickness of the laminated resin layer). The total thickness of the release liner was 108 μm.

A pressure-sensitive adhesive tape was prepared in the same manner as in Example 1 except that this release liner was used.

<Evaluation>

The release liners and pressure-sensitive adhesive tapes according to the aforementioned examples and comparative examples were each tested on outgassing developed when the release liner is heated, resisting force developed when the release liner is peeled off the pressure-sensitive adhesive tape (so-called “releasing force”) and workability of release liner in the following manner to evaluate outgassing upon heating, releasability and workability. The results of evaluation are set forth in Table 1.

<Test for Measuring Outgassing Developed Upon Heating of Release Liner>

The release liner was heated in a purge & trap head space sampler to a temperature of 120° C. for 10 minutes. The gas thus generated was then trapped. The components thus trapped were then subjected to gas chromatography and mass spectrometry. The amount of gas generated was determined as calculated in terms of n-decane (standard). The measurements were then represented by amount per unit area (unit: μg/cm²). The results of measurement are set forth in the column “Outgassing upon heating” in Table 1.

<Test on Releasability>

The pressure-sensitive adhesive tape was cut into a test specimen having a width of 50 mm. Using a universal tensile testing machine, the release liner was then peeled off the test specimen in the direction of 180° at a cross head speed of 300 mm/min in a 23° C. 60%RH atmosphere. The resisting force (releasing force) developed upon peeling (unit: N/50 mm width) was then measured. The results of measurement are set forth in the column “Releasability” in Table 1.

<Test on Workability>

The pressure-sensitive adhesive tape was set in a simple die set mold by which it was then punched into a 6 mm diameter circle. The resulting section of the pressure-sensitive adhesive tape was then observed by a test glass. The workability of the pressure-sensitive adhesive tape was then evaluated according to the following criterion. The results of evaluation are set forth in the column “Workability” in Table 1.

Evaluation Criterion:

G: Fairly cut

P: Not fairly cut due to elongation of release liner; whisker, etc. observed

TABLE 1

| | | Outgassing | | |
|---|---|---|---|---|
| | | developed | Releasablity | |
| | | upon heating | (N/50 mm | |
| | | (μg/cm²) | width) | Workability |
| Example No. | 1 | 0.47 | 0.33 | G |
| | 2 | 0.31 | 0.61 | G |
| Comparative | 1 | 0.82 | 0.81 | P |
| Example No. | 2 | 1.3 | 0.29 | G |
| | 3 | 1.67 | 2.88 | P |

As can be seen in the results of Table 1, the pressure-sensitive adhesive tapes of Examples 1 and 2 according to the invention exhibit a small outgassing developed upon heating and thus have no adverse effects on HDD when incorporated in the interior of HDD as compared with those of Comparative Examples 1 to 3. Further, since the release liners of Examples 1 and 2 have a good laminated structure and are produced by a good production method, the pressure-sensitive adhesive tapes of Examples 1 and 2 have a good releasability and workability. Moreover, the pressure-sensitive adhesive tapes of Examples 1 and 2 are free of base material which gives contaminants such as paper base material and thus can attain a good cleanness. Further, since the pressure-sensitive adhesive tapes of Examples 1 and 2 comprise various layers incorporated therein at a proper ratio, no curling can occur at the step of producing the release liner, etc.

While the invention has been described in detail and with reference to specific embodiments thereof, it will be apparent to one skilled in the art that various changes and modifications can be made therein without departing from the spirit and scope thereof.

What is claimed is:

1. A release liner comprising the following layers A, B and C, wherein the thickness of the layer A:the sum of the thickness of the layers B and C formed on the either side of the layer A is from 9:1 to 6:4, the total thickness of the release liner is from 40 μm to 150 μm and the total outgassing developed when the release liner is heated to a temperature of 120° C. for 10 minutes is not greater than 1 μg/cm²:
Layer A: Base material (A);
Layer B: Undercoating layer (B) comprising a low density polyethylene formed on at least one side of the layer A; and
Layer C: A releasing layer (C) formed by a mixed resin composition comprising at least two ethylene-based polymers selected from the group consisting of straight-chain low density polyethylene, low density polyethylene and copolymer of ethylene with C₃-C₁₀ α-olefin laminated on the layer B.

2. The release liner according to claim 1, wherein the base material (A) is a film or sheet comprising a polypropylene or a polyester.

3. The release liner according to claim 1, wherein the undercoating layer (B) and the releasing layer (C) are laminated on at least one side of the base material (A) in a tandem process.

4. A pressure-sensitive adhesive tape or sheet comprising a pressure-sensitive adhesive layer (D) having laminated thereon a release liner according to claim 1 in such an arrangement that the pressure-sensitive adhesive layer (D) and the releasing layer (C) come in contact with each other.

5. The pressure-sensitive adhesive tape or sheet according to claim 4, which is a pressure-sensitive adhesive tape or sheet for hard disk drive.

6. The release liner according to claim 1, wherein the thickness of the base material (A) is from 10 μm to 100 μm.

7. The release liner according to claim 1, wherein the low density polyethylene related to the undercoating layer (B) has a melt flow rate of from 4 to 15 g/10 min.

8. The release liner according to claim 1, wherein the thickness of the undercoating layer (B) is from 5 μm to 20 μm.

9. The release liner according to claim 1, wherein the ethylene-based polymer related to the releasing layer (C) has a melt flow rate of from 4 to 15 g/10 min.

10. The release liner according to claim 1, wherein the thickness of the layer A:the sum of the thickness of the layers B and C formed on the either side of the layer A is from 8:2 to 7:3.

11. The release liner according to claim 1, wherein the total thickness of the release liner is from 50 μm to 120 μm.
